(19) United States
(12) Patent Application Publication
(10) Pub. No.: US 2008/0129253 A1
(43) Pub. Date: Jun. 5, 2008

(54) Battery energy reclamation apparatus and method thereby

(75) Inventors: Lih-Ren Shiue, Hsinchu (TW); Thomas Li Chen, Sugar Land, TX (US); Min-Chu Chen, Sugar Land, TX (US); Harumoto Nishikawa, Tokyo (JP); Masami Goto, Tokyo (JP)

Correspondence Address: REED SMITH LLP, Suite 1400, 3110 Fairview Park Drive, Falls Church, VA, 22042, US

(73) Assignee: Advanced Desalination Inc.

(21) Appl. No.: 11/592,135

(22) Filed: Nov. 3, 2006

(51) Int. Cl. H02J 7/00

(52) U.S. Cl. 320/167

(57) ABSTRACT

An energy-reclamation apparatus of the present invention including at least a supercapacitor element connected with a charging source and a controlled circuit. After the supercapacitor element is charged to the potential of the charging source, the supercapacitor element and the charging source will work in series to conduct a repetitive polarity reversal of the supercapacitor element through a controlled circuit. As the supercapacitor element discharges, it is reversely charged concurrently. In other words, while the voltage of the supercapacitor element is decreasing on the side, a negative potential is complementarily developing on the other side. By repeatedly reversing the polarity of the supercapacitor element, more energy from the serially connected charging source can be reclaimed and reused.

### BACKGROUND OF THE INVENTION

1. Field of the Invention

The present invention relates to an energy-reclamation apparatus, and more specifically, to the utilization of the characteristics of non-polarity and the high power density of the supercapacitor element as a charge pump to extract more energy from a charging source.

2. Background of the Related Art

The present invention is also a continuation to another application of US Patent, whose filing Ser. No. 10/905,190, “Power Supply apparatus and Power Supply method” filed on Dec. 21, 2004, and now is U.S. Pat. No. 7,085,123.

The use-time of a battery for a portable device, such as, laptop, handheld or cell phone, is profoundly affected by the internal resistance of the battery, also known as ESR (equivalent series resistance), and the discharge rate of the battery. Although rechargeable or secondary batteries (for example, nickel metal hydride and lithium ion), dominate many handheld electronic devices, the non-rechargeable or primary batteries still possess a large share in many markets using portable energy. As the discharge curve of a battery determines its use-time, the primary batteries have a disadvantageous sloping discharge curve as shown in FIG. 1. Initially, the primary batteries suffer a great drop in voltage as they discharge, which leads to a great loss of use-time. At the middle section of discharge, the voltage drop of primary batteries is still quickly sloping. The quick voltage decay of the primary batteries at discharge is due to the increase of ESR with the progress of discharge. Additionally, the drop of battery voltage accelerates with the discharge rate of the battery. When the output current of the primary batteries is increased from 640 mA to 1.5 A, the voltage drop could correspondingly jump from 44 mV to 300 mV per discharge. Even at the end of battery life, there is more energy left than the energy expended. The residual energy of battery at the endpoint of use-time may be calculated by dividing the end voltage by the initial value. Nominally, the primary battery is fabricated at 1.5 V per cell initially, and the end voltage is assumed 0.8 V. Then, at the termination of primary battery at 0.8 V, the unused energy is 0.8/1.5, or 53.3%. If the primary battery is used to drive some high energy-consumption loads (for example, MP3 and wireless data transmission), the battery will become disable at higher voltages leaving more energy unused. Nevertheless, such “drained” batteries can work perfectly for low energy-consumption devices (such as, radios and LED lights) for a long period of time.

Obviously, the conventional use of primary batteries is very wasteful in terms of energy utilization. Moreover, the worldwide production of primary batteries in China alone is more than 20 billion pieces per year. Because of the low recycle rate of primary batteries everywhere, the disposal of the batteries is a great burden to the environment. An effective method for improving the energy efficiency of primary batteries is needed for both energy conservation and environmental protection. The foregoing target may be attained through three approaches: dynamic voltage scaling (DVS), load leveling and energy reclamation. DVS, also known as adaptive voltage scaling, is a technique that dynamically provides the power needed by the primary functions, meanwhile it shuts off the power for the non-essential accessories. A smart central processing unit (CPU), or other electronic circuitries, controls a clock circuit to resume power provision to the secondary functions when the time comes. Energy conservation using DVS has been revealed in U.S. Pat. Nos. 3,978,392; 6,233,016; 6,653,816 and 6,835,491. Nevertheless, DVS is not designed to prevent batteries from high rate discharge. In order to assist the primary battery on minimizing the peak loads, a nickel-cadmium battery (Ni—Cd) is used in U.S. Pat. No. 5,418,433 as a load leveling device. Ni—Cd has a memory effect that will prematurely shorten its lifetime, not to mention the environmental issue of cadmium metal. Rather than for a primary battery, U.S. Pat. Nos. 6,370,046 and 7,015,674 have taught the use of supercapacitor and ultracapacitor for load leveling for some types of secondary batteries. Transformers and excessive electronic components are employed in the aforementioned load leveling. As far as the energy reclamation is concerned, U.S. Pat. No. 4,150,307 claims that the feed back of residual energy in a charging inductor can be transferred into a storage capacitor of the power supply through a transformer. Similarly, U.S. Pat. No. 4,595,975 claims that a counter electromotive force induced at inductive loads becomes a retrievable energy. Regardless of the previous efforts on improving the energy efficiency of all batteries, an effective method for reclaiming the energy stored in the primary batteries along with the reduction of the voltage drop of the batteries at discharge is not available yet. In coping with going-up oil price, methods of energy conservation are constantly and urgently needed.

### SUMMARY OF THE INVENTION

An object of the present invention is to provide an apparatus for both energy reclamation and load leveling to the non-rechargeable batteries (also called primary batteries) by using supercapacitors. While the load leveling may extend the use-time of the batteries via the minimization of their voltage drops at discharge, the energy reclaimed certainly will provide the non-rechargeable batteries additional resource for working longer.

The present invention provides an energy-reclamation apparatus and a method thereby, which comprising:
(1) at least a charging source (such as primary batteries or so-called “non-rechargeable battery”);
(2) at least a symmetrical supercapacitor element connected serially with the charging sources, which contains two identical electrodes with no polarity until they are charged. As the supercapacitor and the charging sources work together, reverse charging of the supercapacitor is proceeded simultaneously with the discharged supercapacitor element; and
(3) a controlled circuit connected with the charging source and the supercapacitor element, wherein the controlled circuit including at least an inverting circuit being inverted the polarity of the supercapacitor element based on an absolute potential difference between a forward-discharging potential and a reverse-charging potential of the supercapacitor element for driving a load.

In most of the manufacturing of supercapacitor elements, their two electrodes are made of identical materials and identical formulations. Thus, the electrodes of the supercapacitor element bear no polarity until they are charged. Even after the first charging, the electrodes of the capacitor can be recharged to a different polarity from the previous charging in the afterwards charging. Hence, the supercapacitor element has no permanently designated polarity for its two electrodes. On the contrary, batteries and conventional capacitors, such as, aluminum electrolytic capacitors, have fixed electrode polarities permitting no interchange of polarity. As the voltage of the supercapacitor element decays with the progress of discharge, a complementary negative potential is being built. When the positive potential is exhausted and a negative potential is fully created, or a balance point is reached, the supercapacitor element will become open allowing no current to pass through. The reverse charging has converted the connection between the supercapacitor element and the charging source from a series configuration to a parallel configuration, therefore, there is no current flow to the load to work.

In order to resume power delivery, the polarity of the supercapacitor element must be inverted so that it becomes a series connection with the charging source again. Once that happens, the supercapacitor element will work as a charge pump for the charging source to drive the load with the combined voltages of the two energy devices. The electric current required for driving the load will be primarily provided by the supercapacitor element due to its high power density. Without a transformer or an electronic component, the energy charged to the supercapacitor element by the charging source may be amplified to an output power several folds of the battery alone. The power amplification is due to the fact that the supercapacitor element has much faster discharge rates than the conventional primary battery, or any other batteries for that matter. Furthermore, the supercapacitor element has a lower ESR than the primary battery, thus, the capacitor will respond first to meet the demand of load.

### BRIEF DESCRIPTION OF THE DRAWINGS

The present invention is best understood by reference to the embodiments described in the subsequent section accompanied with the following drawings.

FIG. 1 is a conventional discharge curve of the primary batteries.

FIG. 2 shows a circuit diagram illustrated a closed circuit consisting of battery, a supercapacitor and a load connected in series for a an energy-reclamation apparatus of the present invention.

FIG. 3 is a flowchart illustrated the energy-reclamation method of the preferred embodiment of the present invention.

FIG. 4 is a circuit diagram of the preferred embodiment of this invention illustrated switching mechanism for repetitive inversion of the polarities of supercapacitor for extracting energy stored in battery.

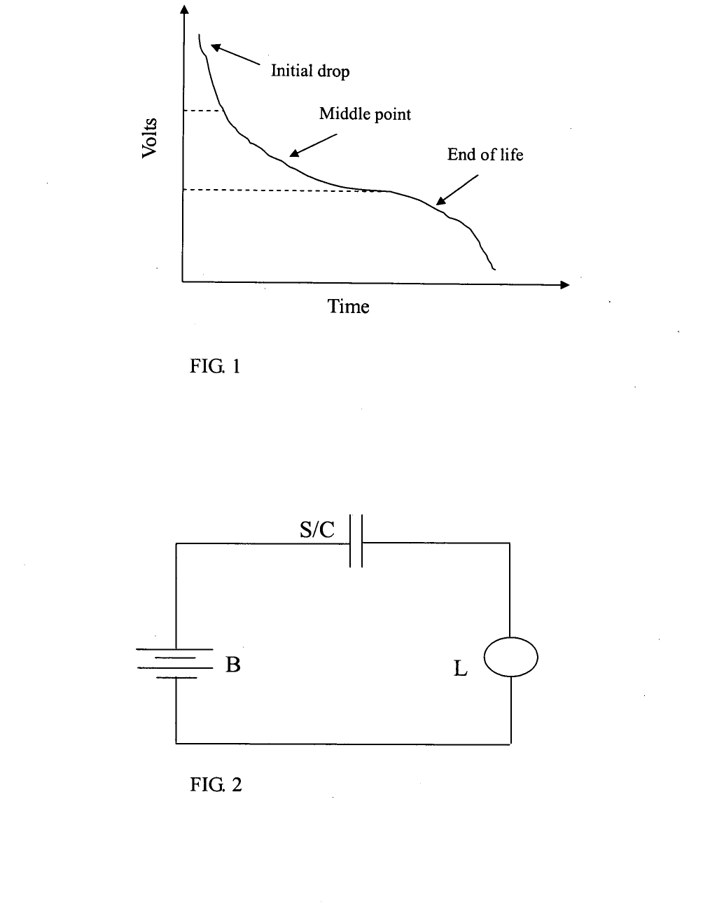

### DETAILED DESCRIPTION OF THE INVENTION AND BEST MODES

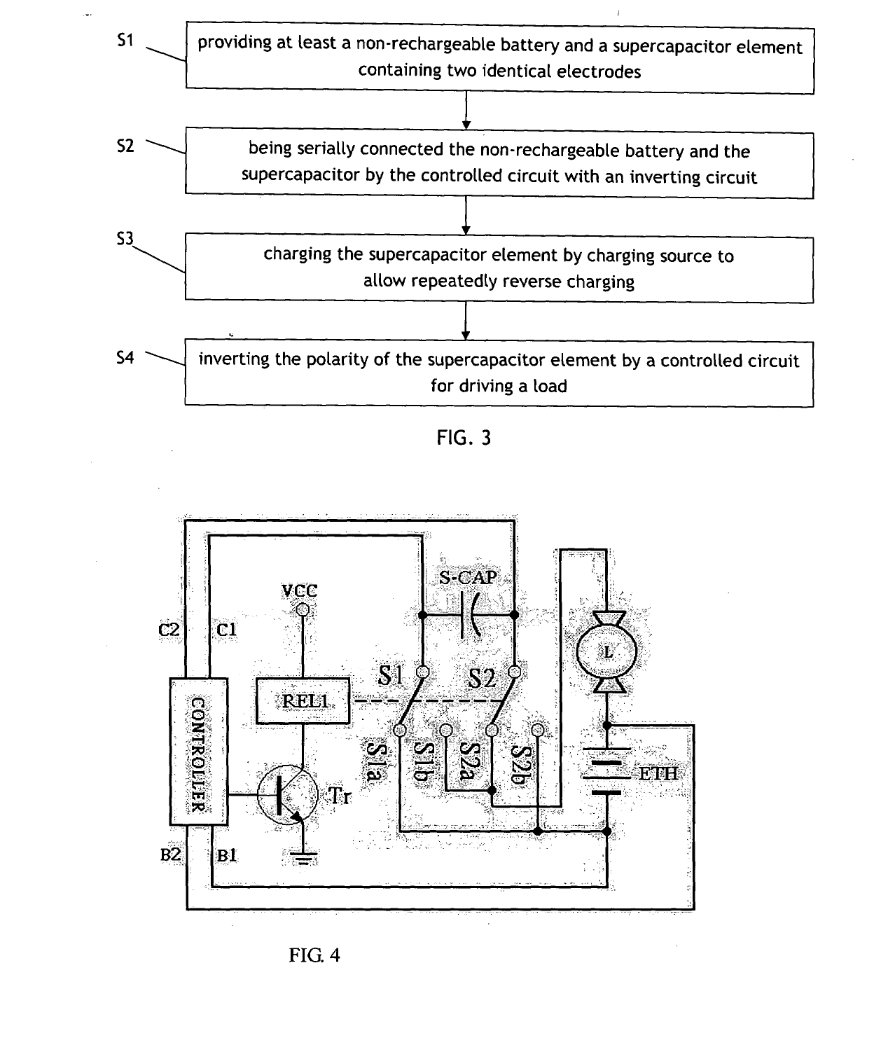

The preferred embodiments of the present invention are described in detail by referring to the accompanying diagrams, wherein the preferred embodiment of the invention shown in FIG. 2 and FIG. 3 is clearly disclosed an energy-reclamation apparatus and a method thereof that including at least a supercapacitor element (hereinafter so-called “supercapacitor”) as a charge pump connected with the charging source (such as primary battery or so-called “non-rechargeable battery”) for reclaiming more energy by a controlled circuit inverting the polarity of the supercapacitor.

FIG. 2 shows a circuit diagram illustrated a closed circuit consisting of battery, a supercapacitor and a load connected in series for an energy-reclamation apparatus of the present invention. In the present invention, the supercapacitor is a symmetrical supercapacitor, which has not only two electrodes with no polarity until they are recharged, but also the capacitance of the symmetrical supercapacitor (so-called “symmetrical supercapacitor” hereinafter) is 0.1 F and above. Moreover, identical materials including active materials for adsorbing ions, additives and current collectors or substrates are used to fabricate the two electrodes of the supercapacitor. Therefore, either electrode can serve as anode or cathode at every charging. Once the supercapacitor is fully charged, its electrodes will carry the same polarity as the poles (not shown in figures) of the non-rechargeable battery that the electrodes are connected for charging.

In a FIG. 2, the circuit is closed circuit consisting of one or more non-rechargeable battery (represented by “B” in FIG. 2), at least a symmetrical supercapacitor (represented by “S/C” in FIG. 2) and a load (represented by “L” in FIG. 2) connected in series. Because the non-rechargeable battery B has fixed polarities assigned to its electrodes, the “B” is represented by parallel bars in different lengths, wherein longer bars are the positive poles and shorter ones are negative poles. In the same token, the symmetrical supercapacitor S/C is also represented by a pair of parallel bars in equal length for the non-polar characteristics. When the symmetrical supercapacitor S/C has no energy stored, the non-rechargeable battery B is the only power source to drive the load L at the beginning.

Referred to FIG. 2 illustration, while electric current or electricity is delivered from the B to the L, it will pass the S/C and charge the S/C at the same time. As long as the potential of the S/C is lower than that of any charging source, the S/C will be charged quickly and efficiently (without energy conversion) to the potential of the charging source. The time required to fully charge a S/C depends on the device's capacitance and resistance. The larger the product of resistance (R) and capacitance (C) (or RC constant), the longer the charging takes. Likewise, the use-time of a S/C is also determined by its capacitance. When the S/C is fully charged to the potential of the B, its electrodes will berry the same polarities as the electrodes of the B connected for charging. As shown in FIG. 2, one bar of the S/C is connected to the positive pole of the B and it becomes positive after charging, whereas the other bar of the S/C hooked to the negative pole of the B will become negative after charging. Hence, the S/C and the B are using the same two poles for the connection, or they are in a parallel configuration. No current of the B is permitted to pass through the S/C to the L in a circuit as FIG. 2. The bulb L would not light unless the S/C and the B are switched to the series hookup. Thus, the polarity of the S/C must be inverted into a series connection with the B for electric current to flow to the L. By then, the voltage applied to L will be the combined voltages of the S/C and the B, or two times the voltage of the B since the S/C is charged to the voltage of the B. For non-directional loads, such as, tungsten light bulb, either the reversely charged S/C or the B can be inverted to get electric current going to the load. On the other hand, for driving directional loads, for example, LED (light emitting diode), only the inversion of the reversely charged S/C can light up the LED.

As in every electric circuit, the current or a charge flow that comes out of the positive electrode of the B must eventually return to the negative electrode of the B to complete the circuit. For the sake of clarity, FIG. 2 shows that the return route is from the L to the B directly. Actually, the current must return from the L through the S/C to the B. After the S/C is charged, the electrodes of the S/C are polarized and the return current to the B must flow through the negative electrode of the S/C.

Comparing to the positive electrode of the S/C, its negative electrode is lower in potential. When the returned current passes through the negative electrode of the S/C, the adsorption of ions on the negative electrode (as well as on the positive), just like the regular charging of the S/C, will be induced resulting in charge accumulation, or potential build-up in a reverse direction to the previous charging, thus, the S/C is reversely charged. At this time, both electrodes of the S/C carry two different charges simultaneously on their two surfaces. The reverse charging gradually creates a negative potential across the two electrodes of S/C in a synchronized pace with the discharge of the S/C, wherein the voltage is decaying.

Moreover, if the S/C discharges at a higher rate, its voltage will drop at a faster speed accompanied with an equally accelerated development of negative voltage. Finally, as the S/C is drained on one side of electrodes, the other side of the same electrodes of the S/C will be fully recharged, but the created potential is in a opposite polarity. Once again, the S/C becomes open allowing no current to pass through until the S/C is inverted, or the B is inverted in the case of driving non-directional load. The inversion of the S/C polarity will convert the recharged potential into a positive value. Therefore, polarity reversal of the S/C is the only way to utilize the energy stored at the reverse charging, and the reverse charging of the S/C appears to be present with the progress of discharge only.

In reality, reverse charging is an automatic process that energy can be stored freely in the symmetric supercapacitors. The energy is taken from the current returned from the L to the B, and there is no charge current intentionally provided to reversely charging the S/C. Neither a complex charging circuit nor an expensive converter is needed for the spontaneous energy refilling of the supercapacitors. Nevertheless, an inverting controller is required for the polarity reversal of supercapacitor for utilizing the refilled energy automatically. The reverse charging is not applicable to batteries and conventional capacitors that use two different, or unsymmetrical, electrodes for the devices. Also, in the power applications using a pack of serially connected supercapacitors, the reverse charging may cause a problem on the reliability of the supercapacitor pack. If the return current of an application is allowed to flow through the supercapacitor pack, the reverse charging may impart a different level of voltage buildup to each pack member. Then, an uneven voltage distribution is likely to occur among the pack member at the forward charging of the supercapacitor pack. The less-reversely-charged S/C may become overcharged during the forward charging, which may cause an earlier failure of that S/C dragging the whole pack with it.

Referred to FIG. 2 shown, FIG. 3 is a flowchart illustrated a method of energy-reclamation of the preferred embodiment. As shown in FIG. 3, the energy reclamation method for non-rechargeable batteries or primary batteries further comprises steps as below:
(i) providing at least a non-rechargeable battery connected with at least a symmetrical supercapacitor with capacitance of 0.1 F and above, as the step of S1;
(ii) providing a controlled circuit with at least an inverting circuit being serially connected with the non-rechargeable battery and the symmetrical supercapacitor, as the step of S2;
(iii) charging the supercapacitor element by charging source to allow repeatedly reverse charging, as the step of S3; and
(iv) inverting the polarity of the supercapacitor element by the controlled circuit for driving a load, as the step of S4.

wherein the inverting circuit being inverted the polarity of the two electrodes of the symmetrical supercapacitor and both of its electrodes with no polarity until they are charged. The inverting circuit inverts the supercapacitor based on an absolute potential difference between a forward-discharging potential and a reverse-charging potential of the supercapacitor. If the absolute potential difference is 0.2 V and above, the polarity of the supercapacitor is inverted so that the capacitor can continuously deliver power to load. By repetitive polarity reversal, the supercapacitor works as a charge pump for the non-rechargeable batteries with more energy utilized than without the supercapacitor.

For automatic polarity reversal, the aforementioned controlled circuit includes an automatic switching circuit being selected from groups of a voltage sensor, a microcontroller, an on/off transistor switch and a relay.

An embodiment of the present invention will be described in more detail hereinafter.

FIG. 4 shows such inverting circuit to perform polarity reversal of the supercapacitor when the reverse charging has created a sufficient accumulation of energy. In FIG. 4, the battery and supercapacitor is represented by ETH and S-CAP, respectively, and a load driven by the primary battery B is represented by L, and the controlled circuit including at least an inverting circuit is represented by CONTROLLER, wherein the S-CAP is represented by a vertical bar and a curved line for the negative and positive electrodes since the supercapacitor is charged, and the battery is also represented by two pairs of long and short bars as the battery B. Both S-CAP and ETH are monitored by a CONTROLLER via buses C1/C2 and B1/B2, respectively.

The CONTROLLER for automatic polarity reversal is further comprised of electronic components or circuitries that include a voltage sensor, a voltage comparator, control logic and a switch driver (not shown in FIG. 4). Assuming S-CAP is fully charged, it will discharge in series with ETH with the following current flow:

ETH→L (load)→S2a→S2→S-CAP→S1→S1a→ETH. (route 1)

and wherein, the returned current will start from L through the negative electrode of S-CAP to ETH. As the current returns from L to ETH through S-CAP, the supercapacitor will be reversely charged along with the discharge of S-CAP.

In the preferred embodiment of the present invention, when the absolute difference between the discharging voltage and the reverse charging voltage reaches a preset point, for example, 0.2 V, the CONTROLLER will turn on the field effect transistor (FET) Tr, which in turn will actuate the relay REL1, a double pole single throw (DPST) electromagnetic switch, which is powered by VCC, to change the electrode connections of S-CAP from S1a/S2a to S1b/S2b. Thereby, the discharge path becomes:

ETH→L S1b→S1→S-CAP→S2→S2b→ETH. (route 2)

Comparing the route 1 and 2, the current flow in the discharge after the polarity reversal is in a reverse direction through the electrodes of S-CAP. As long as the discharging voltage can sustain the smooth operation of the L, the polarity reversal can be actuated at other potential differences between forward discharging and reverse charging. Time delay can also be used as the control to initiate the polarity reversal of the supercapacitor. Furthermore, if the L is a non-polar device, such as a tungsten light bulb, which can be driven in either direction, the polarity reversal can be applied to the battery ETH to utilize the energy stored in the S-CAP from the reverse charging.

An inverting circuit such as FIG. 4 can be built within the housing of a supercapacitor to form a smart supercapacitor ready to work with the primary batteries for higher power output and longer use-time for the latter. The inverting circuit and the supercapacitor can also be permanently built in many appliances so that the devices may be operated by fewer batteries for the same quality of performance as the conventional and wasteful use of batteries. In addition, what is to be emphasized is that, the different from U.S. Pat. No. 7,085,123, precursor of the present invention, on inverting the polarity connection, the smart supercapacitor of the present invention is designed for sustainable extraction of battery energy, particularly, the primary batteries.

Moreover, the present invention further extends the load leveling effect to energy extraction for further improving the energy efficiency of the primary batteries. When two primary batteries are discharged in series, the discharging voltage is the sum of the voltages of the two devices. However, the discharging current is just as large as the current output of either battery (the two batteries should have the same current output). Thus, as one primary battery discharges from 1.5 V to 0.8V, the combined voltage of two serially connected batteries, 1.6 V, may be sufficient to drive many loads, yet, their current output is too low to push the loads.

On the contrary, if a supercapacitor is discharged in series with a primary battery, the output current will be much higher than that of two batteries working in series. Even at the cut-off voltage of the primary battery, that is, 0.8 V, the supercapacitor-battery combination can still deliver sufficient power to many loads due to the high power density of supercapacitor. Concurrently with the discharge of supercapacitor, it is reversely charged. So long as the voltage of supercapacitor is lower than that of the battery, the latter will charge the former automatically to allow the continuation of energy reclamation. The charging speed is determined by how much energy is left in the battery. Even at very low current output of battery, the supercapacitor will be eventually charged to the voltage of battery. Then, the supercapacitor will provide all the required power to the loads. During the discharge of supercapacitor, it will be reversely charged, and the cycle will go on and on until the battery is “truly” drained.

By repetitive inversion of the polarity of supercapacitor, the energy stored in the primary battery will be extracted until the battery is virtually exhausted. Such energy extraction would not occur in the serially connected batteries, for a primary battery cannot charge another primary battery. The supercapacitor can serve as a charge pump and an energy extractor for the primary batteries. The following example can illustrate the energy extraction of a primary battery by a supercapacitor and a switching circuit of the present invention.

### The Practical Example for the Preferred Embodiment

The example for the preferred embodiment is from a toy car running on a DC motor that consumes a maximum current of 0.5 A, and the motor is driven by two different power sources Power A and Power B until the primary battery, which serves as the charge source for both A and B, is exhausted. There are two AA (number 3) alkaline batteries connected in series in Power A, each is 1.5 V, 2,850 mAh capacity, and 0.15 Ω ESR. A same alkaline battery is connected in series with a home-made AA supercapacitor at 2.5 V, 3 F capacitance and 20 mΩ ESR in Power B. The polarity of the supercapacitor is inverted when the discharging voltage of the combination has become 0 V, and test results are listed in Table 1 hereinafter.

TABLE 1
Run-time of a DC Motor Driven by Two Alkaline Batteries or
An Alkaline Plus A Supercapacitor with Automatic Polarity Reversal

| | Cut-off V | Run-time of |
|---|---|---|
| Power Sources | of Alkaline | Motor (hours) |
| A | 1.4 V | 3 |
| B | 0.7 V | 11 |

From the result listed in Table 1, the average voltage of each alkaline battery in the power source A is 0.7 V, which is same as that in the power source B. Nevertheless, power source B, the combination of battery and supercapacitor, has almost 4 times of use-time of power source A, the battery only. During the test, the supercapacitor has been observed to discharge from 1.2 V to 0 V, and at the mean time, the capacitor is reversely charged to −1.2 V. The discharge curve of source B is flat, whereas that of source A is sloping, a typical discharge curve of primary battery. Therefore, the supercapacitor in conjunction with the technique of polarity reversal of the present invention has significantly improved the discharge behavior and use-time of the primary battery.

Finally, it will be emphasized that the charge source in the foregoing embodiments has been disclosed using non-rechargeable batteries as exemplary preferred form. However, any energy-reclamation apparatus will occur to the skilled artisan through the exercise of ordinary aptitude, such as modified apparatus with charging-discharging, it is to be understood that the scope of the invention is not limited to the disclosed embodiments. On the contrary, it is intended to cover various modifications and similar arrangements. Therefore, the scope of the appended claims should be accorded the broadest interpretation so as to encompass all such modifications and similar arrangements.

What is claimed is:

1. An energy-reclamation apparatus, comprising:
at least a charging source;
at least a supercapacitor element connected with said charging source; and
a controlled circuit connected with said charging source and said supercapacitor element;
wherein said controlled circuit including at least an inverting circuit being inverted the polarity of said supercapacitor element for driving a load.

2. The energy-reclamation apparatus in accordance with claim 1, wherein said supercapacitor element is a symmetrical supercapacitor.

3. The energy-reclamation apparatus in accordance with claim 1, wherein said supercapacitor element has a capacitance of 0.1 F and above.

4. The energy-reclamation apparatus in accordance with claim 1, wherein said supercapacitor element further contains two identical electrodes with no polarity until they are recharged.

5. The energy-reclamation apparatus in accordance with claim 4, wherein each of said electrodes is made of identical active materials for ion adsorption, additives and current collectors.

6. The energy-reclamation apparatus in accordance with claim 1, wherein said supercapacitor element allows reverse charging.

7. The energy-reclamation apparatus in accordance with claim 6, wherein said reverse charging proceeds concurrently with the discharge of said supercapacitor element.

8. The energy-reclamation apparatus in accordance with claim 1, wherein said inverting circuit further comprising an automatic switching circuit being selected from groups of a voltage sensor, a microcontroller, an on/off transistor switch and a relay.

9. The energy-reclamation apparatus in accordance with claim 1, wherein said inverting circuit inverting said supercapacitor element based on an absolute potential difference between a forward-discharging potential and a reverse-charging potential of said supercapacitor element.

10. The energy-reclamation apparatus in accordance with claim 9, wherein said absolute potential difference is 0.2 V and above.

11. The energy-reclamation apparatus in accordance with claim 1, wherein said charging source is a non-rechargeable battery.

12. The energy-reclamation apparatus in accordance with claim 1, wherein said load is a non-directional load.

13. A method of energy reclamation, comprising steps of:
providing at least a charging source connected with at least a supercapacitor element;
providing a controlled circuit connected with said charging source and said supercapacitor element;
charging said supercapacitor element by said charging source; and
inverting the polarity of said supercapacitor element by said controlled circuit for driving a load.

14. The method of energy reclamation in accordance with claim 13, wherein said charging source is a non-rechargeable battery.

15. The method of energy reclamation in accordance with claim 13, wherein said supercapacitor element has a capacitance of 0.1 F and above.

16. The method of energy reclamation in accordance with claim 13, wherein said supercapacitor element further contains two identical electrodes with no polarity until they are charged.

17. The method of energy reclamation in accordance with claim 13, wherein said controlled circuit further including an automatic switching circuit being selected from groups of a voltage sensor, a microcontroller, an on/off transistor switch and a relay.

18. The method of energy reclamation in accordance with claim 13, wherein said controlled circuit inverting said supercapacitor element based on an absolute potential difference between a forward-discharging potential and a reverse-charging potential of said supercapacitor element.

19. The method of energy reclamation in accordance with claim 18, wherein said absolute potential difference is 0.2 V and above.

20. The method of energy reclamation in accordance with claim 13, wherein said load is a non-directional load.
